(19) United States
(12) Patent Application Publication
(10) Pub. No.: US 2024/0158061 A1
(43) Pub. Date: May 16, 2024

(54) OUTBOARD MOTOR COWLING LATCH ASSEMBLY

(71) Applicant: FORZA X1, INC., FT. PIERCE, FL (US)

(72) Inventor: Daniel Norton, FT. PIERCE, FL (US)

(21) Appl. No.: 18/507,782

(22) Filed: Nov. 13, 2023

Related U.S. Application Data
(60) Provisional application No. 63/424,985, filed on Nov. 14, 2022.

(51) Int. Cl. B63H 20/32; E05B 81/08; E05B 81/62; E05C 3/04

(52) U.S. Cl. CPC B63H 20/32; E05B 81/08; E05B 81/62; E05C 3/047

(57) ABSTRACT

The disclosure invention is directed to an outboard motor cowling latch assembly. More specifically, the cowling latch assembly is integrated with a specific safety control circuit and locking solenoid that prevents removal of the cowling during unsafe or hazardous conditions. This provides a number of safety and functional advantages, among other improvements.

### FIELD OF THE INVENTION

The present invention is directed to an outboard motor cowling latch assembly. More specifically, the cowling latch assembly is integrated with a specific safety circuit controller and locking solenoid that prevents that removal of the cowling during unsafe or hazardous conditions.

### BACKGROUND OF THE INVENTION

Cowlings on outboard motors provide a buffer between the user and the potentially dangerous conditions of the motor within. Once an outboard motor is turned off and the motor is no longer carrying a charge, the motor is deemed safe to touch. Depending on the type of motor, the time between the power being removed and the charge dissipating to a safe condition can be many seconds. For example, it may take at least 4 to 10 seconds in a typical electric outboard motor to dissipate its charge and become safe to touch, especially those with an AC motor and inverter. Thus, inadvertent removal of a cowling when the motor still holds a charge could lead to the user being electrocuted.

Therefore, there exists a need for a safety mechanism that can halt the removal of the cowling while the motor still holds a charge.

Conventional outboard motors are mounted high on the boat's transom making it difficult for a single person to lift the motor off of the boat when the boat is on a trailer. Likewise, it can be rather difficult for a solitary user to remove or install an outboard motor in the correct position on a boat. Thus, there exists a need for special grip locations to facilitate easier solitary user removal of the motor off of a boat.

### SUMMARY OF THE INVENTION

A cowling latch assembly comprising: 1) an upper portion configured to attach to a cowling, wherein the upper portion includes a gripping protrusion and a top latch, wherein the top latch is configured to rotate a latch cam or similar structure to engage with a motor body; 2) a lower portion including a locking plate having a receiving aperture; 3) a frame arm including a sensor, a lock pin configured to interface with the latch cam, and a retractable locking actuator such as a solenoid; and 4) a safety circuit controller configured to control the retractable locking solenoid being moved between a locked position and an unlocked position.

The cowling latch assembly above wherein the safety circuit (also referred to as a “safety circuit controller” or “controller”) is configured to control the retractable locking solenoid based on the following input information: condition of motor, position of top latch and whether the motor still has a charge.

Other advantages will become apparent through reading the remaining description, drawings, and claims provided herewith.

### BRIEF DESCRIPTION OF DRAWINGS

The forgoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A illustrates an exemplary embodiment of an outboard motor cowling latch assembly.

FIG. 1B illustrates an exemplary embodiment of an outboard motor cowling latch assembly.

FIG. 2 illustrates an exemplary embodiment of an outboard motor cowling latch assembly in the open position and the cowling being removed from an outboard motor.

FIG. 3 illustrates an outboard motor frame arm capable of receiving the lower portion of the cowling latch assembly.

FIG. 4A illustrates a view of an outboard motor cowling latch assembly.

FIG. 4B a view of an outboard motor cowling latch assembly.

FIG. 5A illustrates an alignment pin and alignment block on an outboard motor cowling.

FIG. 5B illustrates an alignment pin and alignment block on an outboard motor cowling.

FIG. 6 illustrates the gripping protrusion and top latch of an outboard motor cowling latch assembly.

FIG. 7 illustrates the lower portion of the cowl latch assembly with the top latch in the open position.

FIG. 8 illustrates the cowling being lowered onto an outboard motor.

FIG. 9A illustrates the cowling with the latch cam in an open position being lowered onto an outboard motor.

FIG. 9B illustrates the cowling with the latch cam in an open position being lowered onto an outboard motor.

FIG. 10A illustrates the cowling seated on an outboard motor with the latch cam in the closed position.

FIG. 10B illustrates the cowling seated on an outboard motor with the latch cam in the closed position.

FIG. 11A illustrates the lower portion of the cowl latch assembly with the solenoid in the locked position.

FIG. 11B illustrates the logic table used by the safety circuit to indicate whether the solenoid is in a “safe” or “unsafe” state.

### DETAILED DESCRIPTION OF THE INVENTION

As used herein, the term “cowl” and “cowling” are used interchangeably throughout this disclosure. As used herein, the term “about” in conjunction with a numeral refers to a range of that numeral starting from 10% below the absolute value of the numeral to 10% above the absolute value of the numeral, inclusive.

The present disclosure is directed to an outboard motor cowling latch assembly. More specifically, the cowl latch assembly is integrated with a specific safety control circuit and locking solenoid that prevents the removal of the cowling during unsafe or hazardous conditions. This is especially important with electric outboard motors, where the inverter and AC motors still hold a potentially hazardous electrical charge even after disengaging power.

A cowling of an electric motor should not be removed until the electric motor and inverter is safely de-energized which typically takes about 4 to about 5 seconds after powering down the motor. The cowling latch assembly contemplated in this disclosure comprises of an upper portion, wherein the upper portion comprises of a gripping protrusion, and a top latch, wherein the top latch is configured to rotate a latch cam; a lower portion, wherein the lower portion comprises of a locking plate with a receiving aperture; a frame arm, wherein the frame arm comprises of a sensor, a lock pin, wherein the lock pin is configured to interface with the latch cam, and a retractable locking solenoid; and a safety circuit.

While the embodiments herein refer to a solenoid as the actuator to control safety locking of the cowling to the motor, it should be understood that any equivalent actuator may be used without straying from the scope of this invention. A motorized actuator, spring loaded actuator, pneumatic, and the like are also contemplated herein as other ways to release the cowling from the motor in a controlled manner.

The latch position sensor is capable of detecting the position of the latch, and the locking solenoid is capable of preventing the removal of the cowling when the solenoid is in an “unsafe” condition or state.

A latch assembly for a cowl of an outboard motor, made in accordance with a preferred embodiment of the present invention, comprises a top latch handle which is attachable to an upper portion of a cowl latch assembly and a locking plate which is attachable to a lower portion of the cowl latch assembly. The top latch handle is a manual handle that is rotatable about a first axis between first and second positions. The top latch handle may be located on the top of the cowling in a recessed pocket and/or may be directly adjacent to a gripping protrusion.

The latch cam may be configured to exert a force on a lock pin in a direction which is generally parallel to the first axis and/or catch or otherwise engage with the locking pin. The top latch handle and the latch cam are configured to define the second position as a detent position of the handle. The second position is a locking position which retains the top latch handle in a fixed position attached to the upper portion of the cowl latch assembly. The top latch handle also has an unlocked position allowing removal of the cowling from the motor.

In a particularly preferred embodiment of the present invention, a sensor may be located on the motor frame arm in a location where the sensor detects the position of the latch cam or handle. The latch cam (or handle) position feedback is fed into a safety circuit. A locking solenoid is positioned on the motor frame, and engages a locking plate in the lower portion of the cowling assembly to impart a redundant locking force. The safety circuit may be, in this embodiment, configured to read the latch cam sensor and only allow the locking solenoid to retract when the outboard motor is off, AND the latch is physically opened, AND the other criteria has been met for acceptable safety conditions.

As such, the cowling latch assembly is generally configured to provide locking redundancy and an automated safety system to ensure that the cowling is not removed from the motor if there is a danger to the user. The assembly ensures that even if the manual latch has been moved to an unlocked position, the cowling cannot be removed if motor is on and/or the motor is unsafe for human exposure.

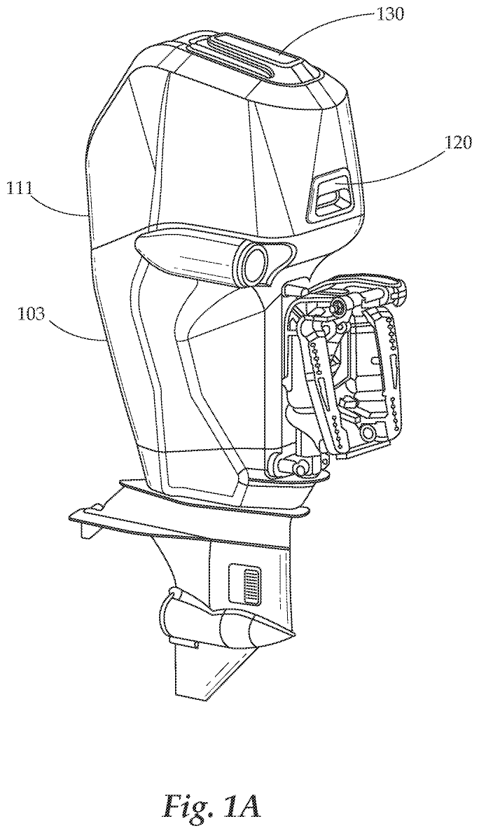

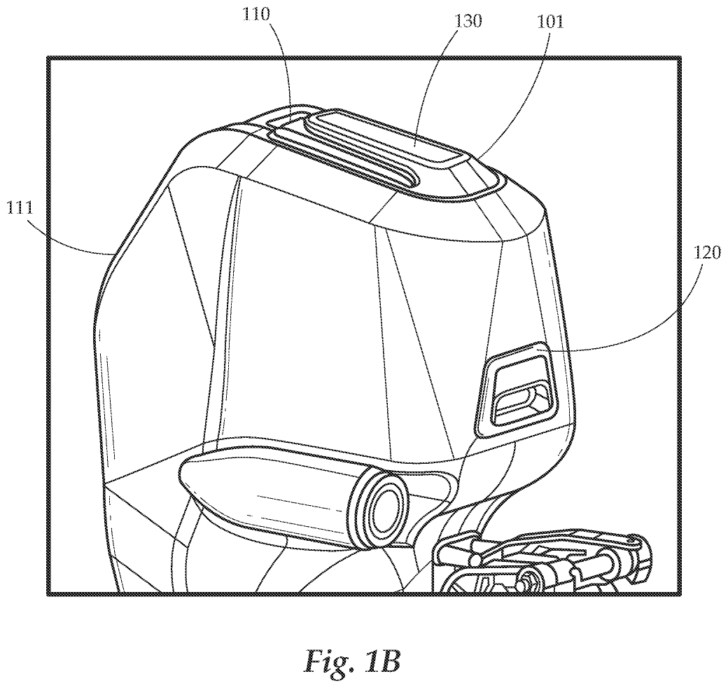

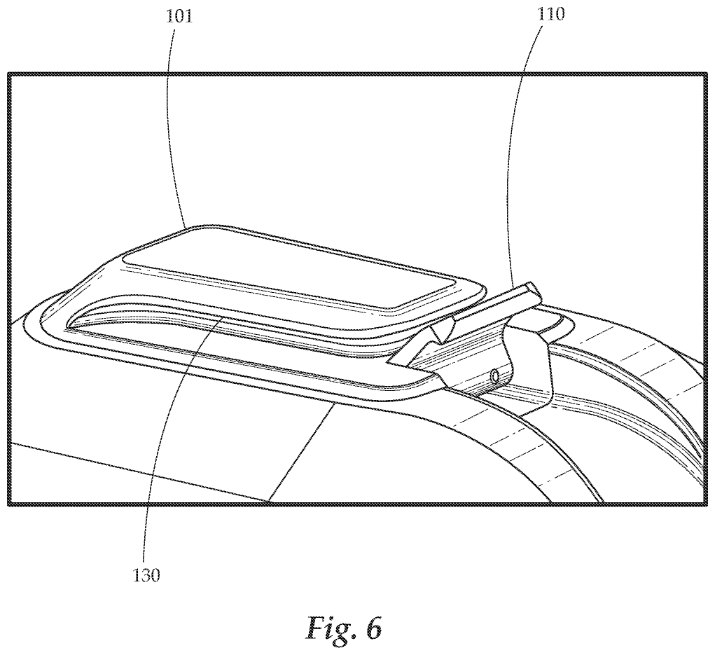

FIG. 1A-1B illustrate an exemplary embodiment of an outboard motor cowling latch assembly. In this embodiment, top latch 110 on upper portion of cowl latch assembly 101 is in the closed and locked position. When manual top latch 110 is in the locked position, gripping protrusion 130 and front handle 120 enable a single user to lift an outboard motor over the transom of a boat. Looking forward to FIG. 6, FIG. 6 illustrates the upper portion of cowl latch assembly 101, gripping protrusion 130, and top latch 110. In this embodiment, top latch 110 is in the open position.

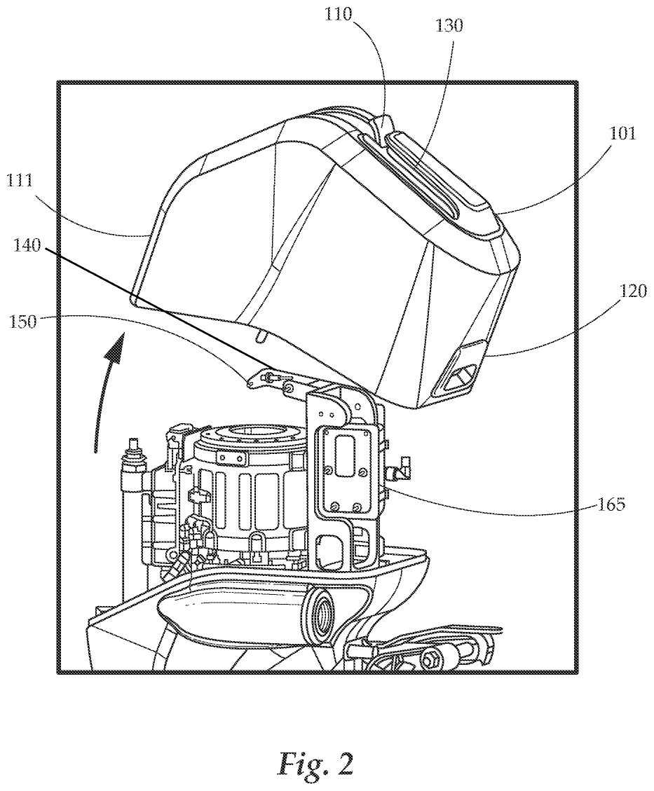

FIG. 2 illustrates an exemplary embodiment of an outboard motor cowling latch assembly in the open position and the cowling 111 being removed from an outboard motor. In this embodiment, top latch 110 on the upper portion of the cowl latch assembly 101 in the open position allowing cowling 111 to be removed enabling access to the motor. When top latch 110 is in the open position, solenoid 140 on a motor frame arm 150 is in an unlocked state. The controller 165 is in communication with the solenoid and controls its movement between the unlocked and locked position.

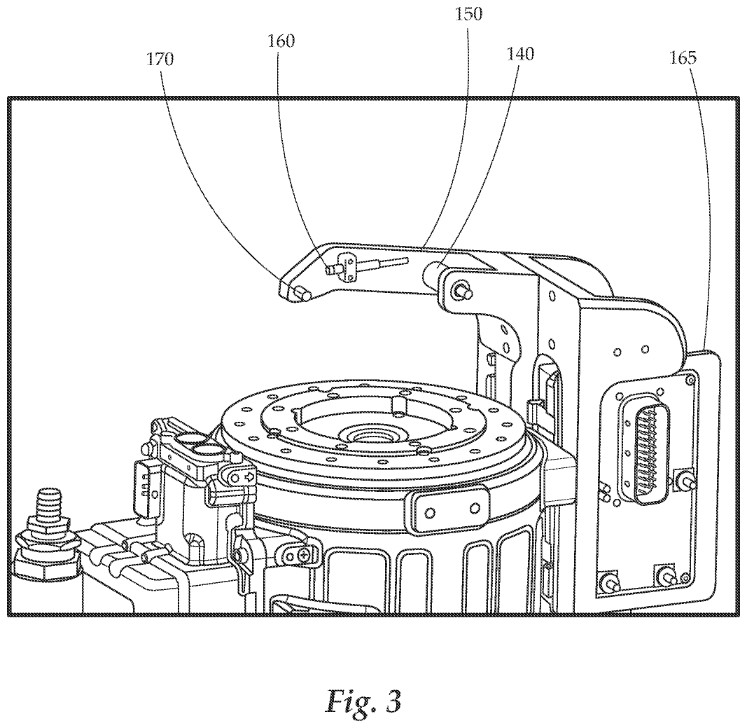

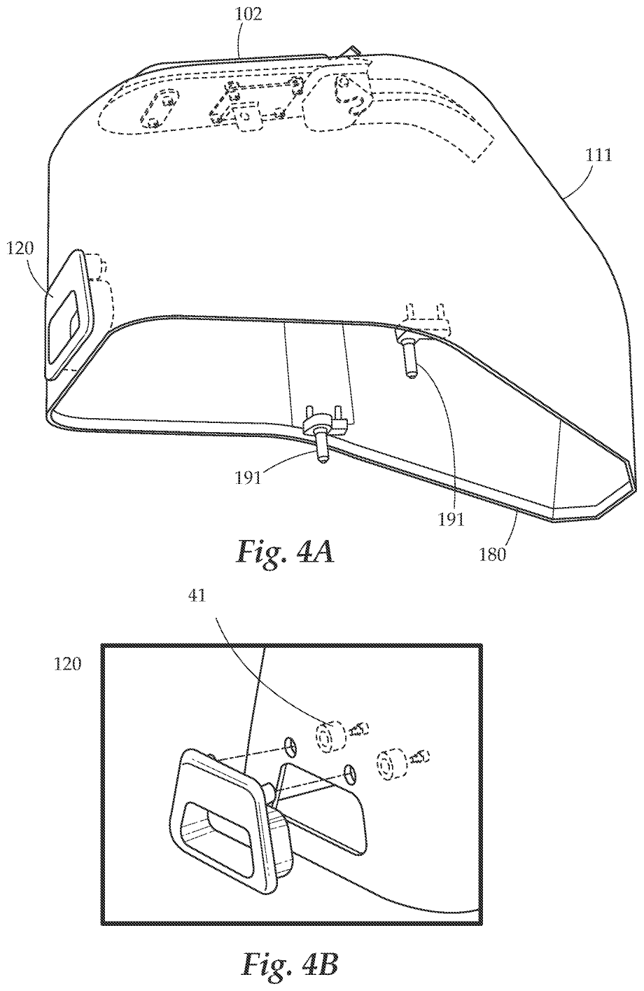

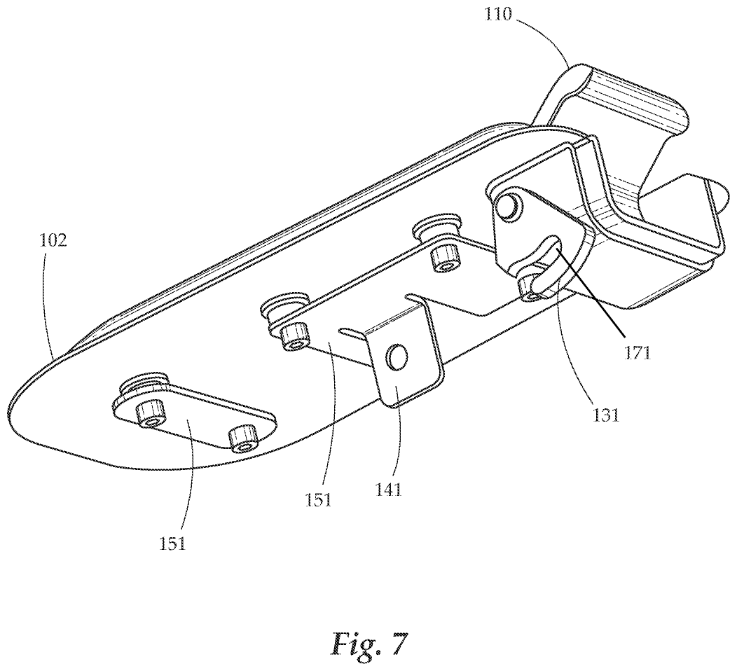

FIG. 3 illustrates an outboard motor frame arm 150 capable of receiving lower portion of the cowl latch assembly 102 (as further shown in FIGS. 4A and 7). Locking pin 170 is permanently affixed to frame arm 150 and receives latch cam 131 (See FIG. 7) of the lower portion of cowl latch assembly 102 when cowling 111 is on the outboard motor. Safety circuit 165 is in communication with a latch position sensor 160, wherein sensor 160 detects the position of latch cam 131 (See FIG. 7) and sends a signal regarding the latch cam position to a safety circuit 165 (also referred to herein as a controller).

In this embodiment, locking solenoid 140 is positioned on the motor frame, and engages locking plate 141 (as seen in FIG. 7) in lower portion of the cowling latch assembly 102. This imparts a redundant locking force to the cowling, preventing unsafe removal. Safety circuit 165 is designed to read latch cam sensor 160 and only allow locking solenoid 140 to retract when the outboard motor is off, AND the latch is physically opened, AND the other criteria have been met for acceptable safety conditions. “Safe” conditions for the motor are discussed in more detail below.

FIG. 4A-4B illustrates various cutaway views of an outboard motor cowling latch assembly. In this embodiment, the lower portion of cowl latch assembly 102, front handle 120, a plurality of alignment pins 191, cowling lip and groove 180 are shown. The cowling lip groove 180 comprises a rubber face seal capable of providing the outboard motor with a watertight seal when cowling 111 is locked to the motor. In addition, the plurality of alignment pins 191 aide in securing cowling 111 to an outboard motor. In this embodiment, front handle 120 is permanently attached to cowling 111 using a plurality of fasteners 141.

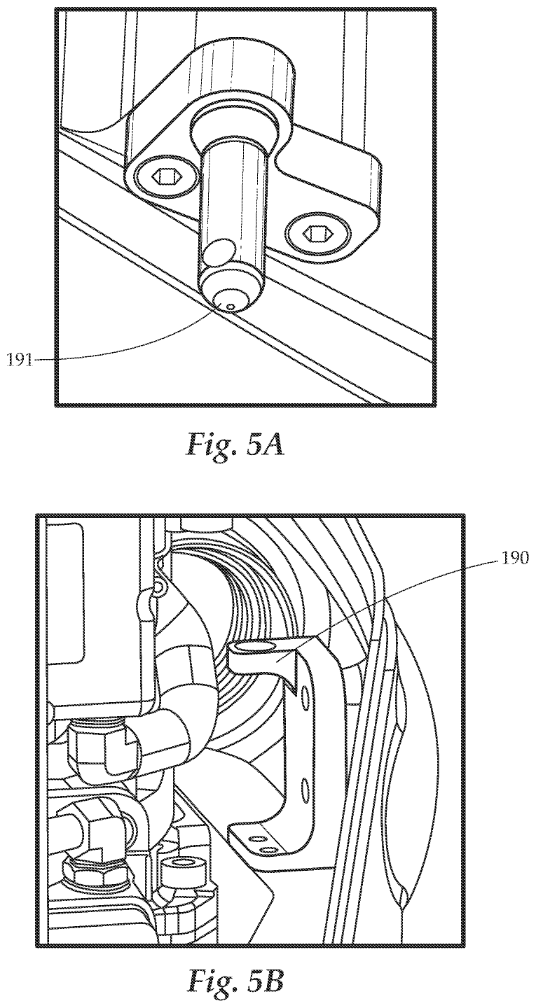

FIG. 5A-5B illustrates an alignment pin 191 and an alignment block 190 mounted to a body of the outboard motor which is used to secure cowling 111 to an outboard motor. Alignment block 190 may be permanently affixed to the frame of the motor and readily accepts alignment pin 191. In an exemplary embodiment, cowling 111 comprises two alignment pins 191 and two alignment blocks 190 on opposite sides of cowling 111. The pins 191 have a curved leading face to aid in self-aligning the pins 191 to their respective blocks 190.

FIG. 7 illustrates lower portion of cowl latch assembly 102, mounting brackets 151, latch cam 131, top latch 110, and locking plate 141. In this embodiment, locking plate 141 comprises of a receiving aperture capable of receiving a pin of the locking solenoid 140. The latch cam 131 engages with locking pin 170 to allow the manual latch to hold the cowling to the motor. When the piston of solenoid 190 passes through the aperture of the locking plate 141, the cowling 111 cannot be removed, even if the manual top latch has been opened. As noted above, this ensures that the cowling is not removed when the motor is dangerously energized which could cause electrical shock risk to a user, among other risks. Detent 71 provides an additional mechanical element to urge and retain the latch cam 131 with the locking pin 170. Mounting brackets 151 hold upper portion 101 and lower portion 102 together and to the cowling 111.

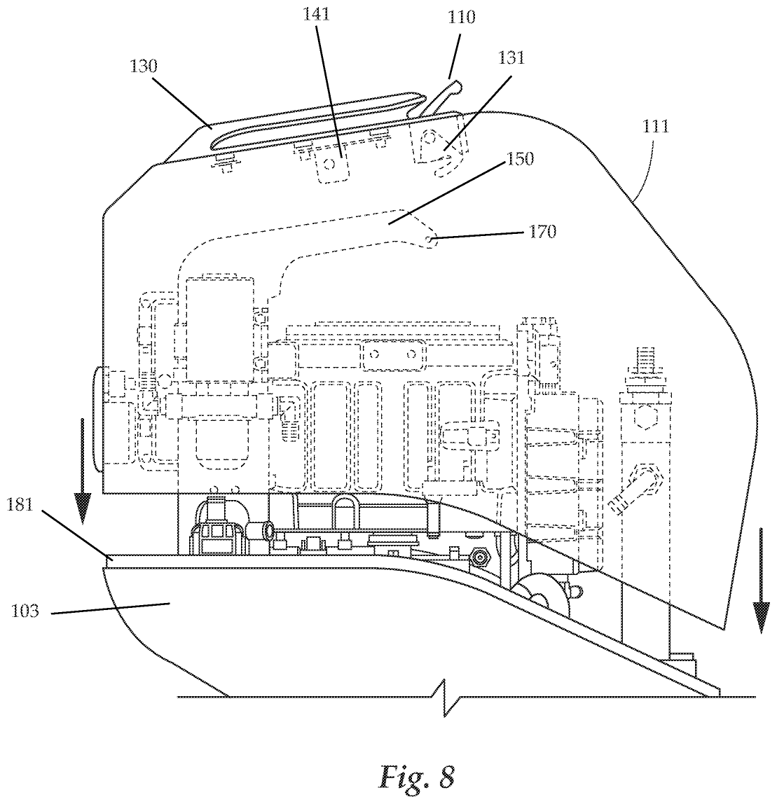

FIG. 8 illustrates cowling 111 being lowered onto an outboard motor. In this embodiment, top latch 110 is in the open position. The top latch 110 is in an open position and causes the latch cam 131 to be open. Locking plate 141 is also spaced away from the motor arm 150 and the solenoid (not shown) to which it will engage. Gripping protrusion 130 is adjacent to the top latch 110. The motor body 103 defines a cowling lip groove 180 which engages around the cowling 111 and provides a water tight seal when engaged.

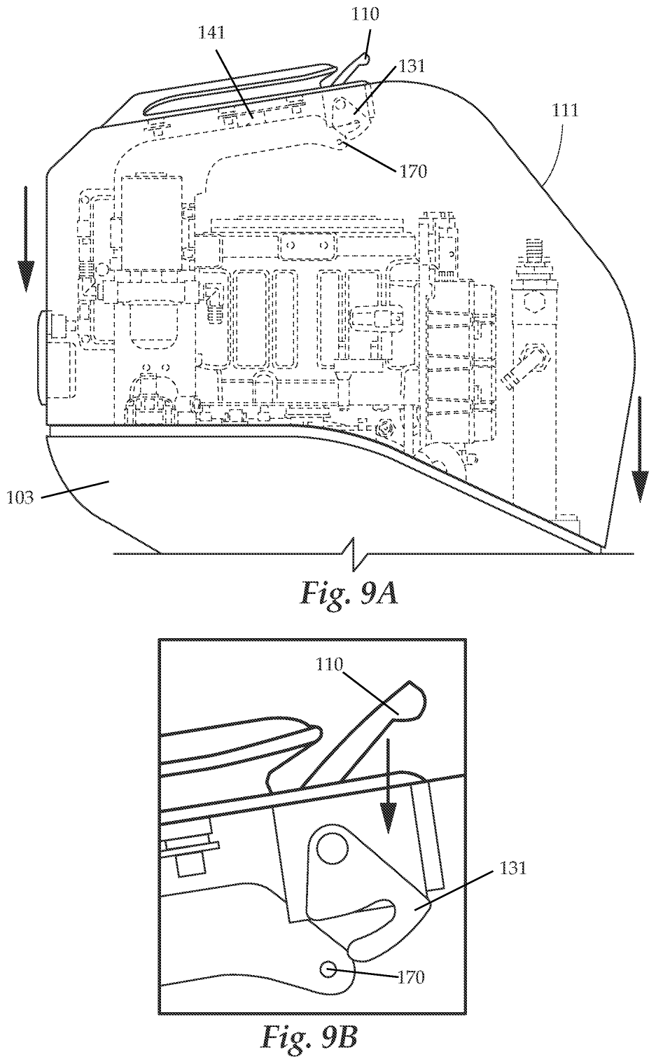

FIG. 9A-9B illustrates cowling 111 with latch cam 131 in an open position being lowered onto an outboard motor 103. The cowling 111 sits on the motor housing 181 and engages around the cowling lip groove 180. Latch 110 is open and latch cam 131 is positioned to nearly engage with the locking pin 170.

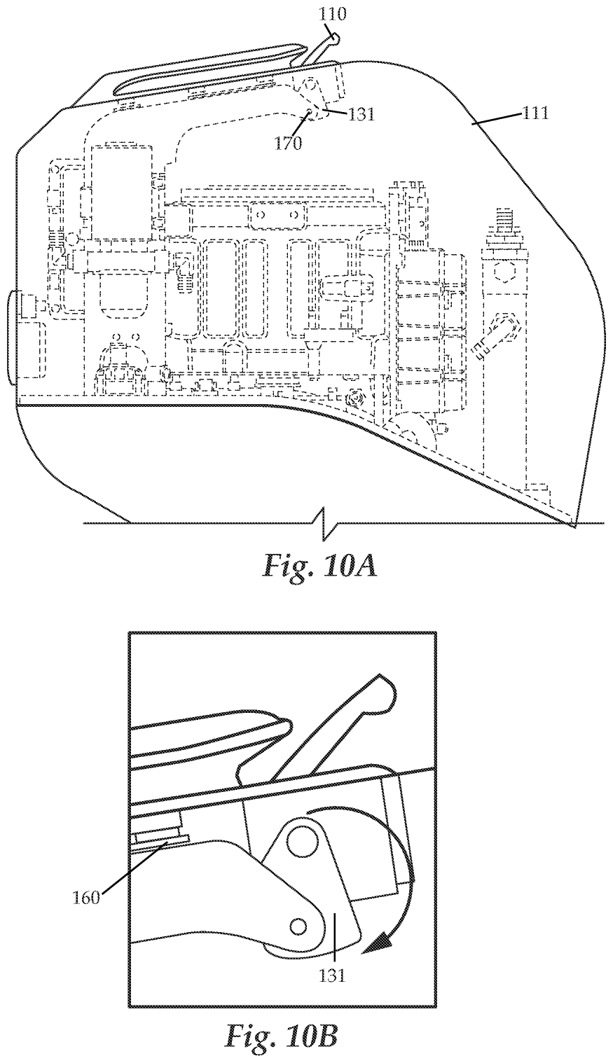

FIG. 10A-10B illustrates cowling 111 seated on an outboard motor with latch cam 131 in a closed position. In this embodiment, latch cam 131 engages lock pin 170 forcing top latch 110 into a closed position. As cowling 111 is lowered, latch position sensor 160 detects the target face on latch cam 131 and the curved shape of the latch cam 131 draws cowling 111 down like a clamp. Once cowling 111 is locked, latch position sensor 160 sends position feedback to the controller of safety circuit 165 providing confirmation that latch cam 131 is in a closed and locked state. In this embodiment, cowling 111 is closed on the motor and cowling lip groove 180 provides a watertight seal for the outboard motor. In this embodiment, lower portion of cowl latch assembly 102 aligns with frame arm 150, and each alignment pin 191 aligns with its respective alignment block 190 (see FIG. 8).

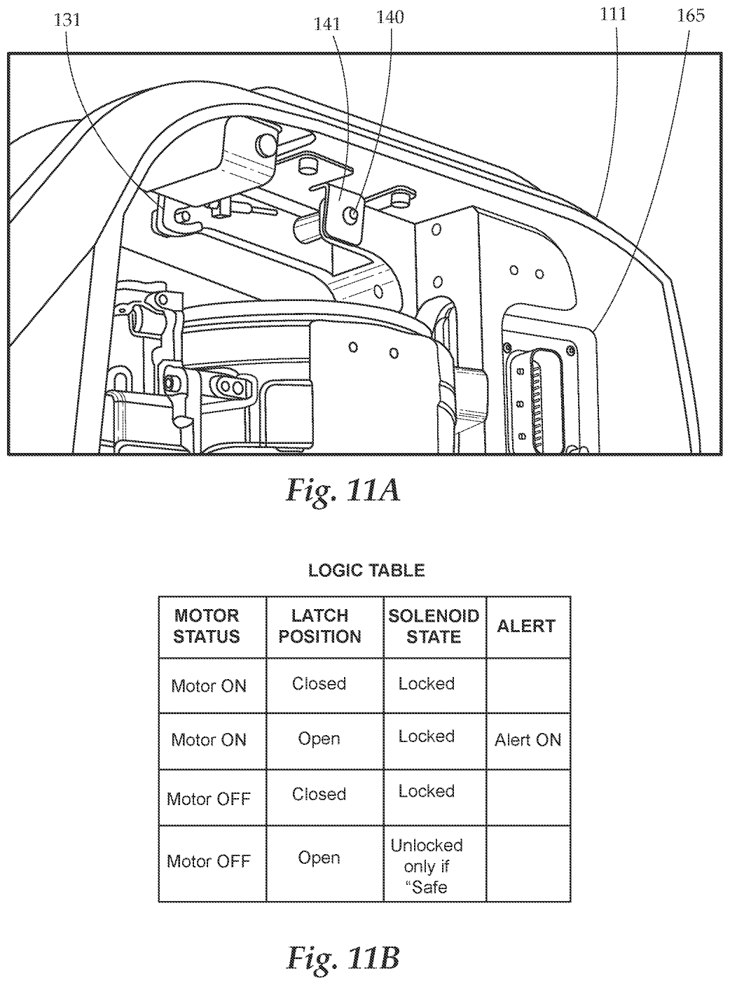

FIG. 11A illustrates lower portion of cowling latch assembly 102 with locking solenoid 140 in the locked position. In this embodiment, the solenoid has position 142 engaged with aperture 140 and locks cowling 111 in place. In addition, the solenoid 140 is of sufficient strength to prevent human force from lifting the cowling up until solenoid 140 is in an unlocked or “safe” state.

FIG. 11B illustrates the logic table used by safety circuit 165 to indicate whether solenoid 140 is in a “safe” or “unsafe” state. If the motor is on and top latch 110 is closed, then solenoid 140 is in a locked state or position. If the motor is on and top latch 110 is open, then solenoid 140 is in a locked state and an alert is on. If the motor is off and top latch 110 is in a closed position, then solenoid 140 is in a locked state. Lastly, if the motor is off and top latch 110 is in the open position, then solenoid 140 will move to an unlocked state or position if it is deemed “safe.” The definition of safe for the purposes of this disclosure is the condition where after the motor is turned off, the live voltage in the inverter and the motor has dissipated which will typically be after about 4 to about 10 seconds. In certain embodiments which use a time frame to determine if the motor is “safe”, a timer may be used. For example the controller may be programmed to determine that the live voltage of the motor has dissipated based on a predetermined time after a detected motor shut off. In another embodiment, a sensor may be used in an inverter that is able to identify when the voltage within the inverter is discharged, this sensor may then send a signal to the safety circuit controller that the motor is in a “safe” state. In embodiments having more than one inverter, a single sensor may track each inverter voltage discharge, or each inverter may have its own sensor, each in communication with the safety circuit controller. In yet another embodiment, the solenoid may be in electrical communication with the inverter or inverters and when the inverter(s) carry a voltage, the solenoid will be activated and in the locked position, and when the inverter is discharged, the solenoid will be de-powered and move to an unlocked position.

In a further embodiment, the cowling latch assembly top portion or another easily visible portion of the motor may provide an indicator light which alerts when the cowling is safe and/or unsafe to be removed. Other indicators such as an audible alarm or may also be used. In one embodiment, only if the manual latch is opened, but the solenoid has not yet released the cowling will an alarm be activated such as the light or audible alarm.

In another similar embodiment, the cowling may be controlled by a single solenoid release, rather than the above noted combination manual and solenoid release. In such an embodiment, the programming of the solenoid controller may be similar, and release may be actuated by a button or latch, which triggers solenoid actuation (releasing the lock on the cowling) unless the motor is on or the motor is not in the safe condition.

In various embodiments, the solenoid may draw power from a same battery that powers the motor, or may utilize a separate battery or other power source.

While, the principles of the invention have been described herein, it is to be understood by those skilled in the art that this description is made only by way of example and not as a limitation as to the scope of the invention. Other embodiments are contemplated within the scope of the present invention in addition to the exemplary embodiment shown and describe herein. Modifications and substitutions by one of ordinary skill in the art are considered to be within the scope of the present invention.

1. A cowling latch assembly for an outboard motor comprising:
a manual top latch on an outside of a cowling, the manual top latch configured to hold the cowling in place to the outboard motor in a locked position, and configured to release the cowling from the outboard motor in an unlocked position;
a locking actuator, the locking actuator separate from the manual top latch and in communication with a controller, the locking actuator operable to hold the cowling in place to the outboard motor in a locked position when the manual top latch is in the unlocked position, and operable to release the cowling from the outboard motor in an unlocked position;
wherein the controller is operable to move the locking actuator to the unlocked position if the manual top latch is in the unlocked position, a motor of the outboard motor is off, and a live voltage of the motor has dissipated.

2. The cowling latch assembly of claim 1 wherein the actuator comprises a solenoid.

3. The cowling latch assembly of claim 2 wherein the solenoid comprises a piston, wherein the piston is movable to engage with a plate on the cowling when the actuator is in the locked position, and movable to disengage from the plate on the cowling when in the unlocked position.

4. The cowling latch assembly of claim 3 wherein the plate extends from a top surface of an inside of the cowling.

5. The cowling latch assembly of claim 1 wherein the controller is programmed to determine that the live voltage of the motor has dissipated based on a predetermined time after a detected motor shut off.

6. The cowling latch assembly of claim 1 further comprising a sensor to detect that the manual top latch is in the unlocked position, the sensor in communication with the controller.

7. The cowling latch assembly of claim 1 wherein the cowling further comprises a gripping protrusion adjacent to the manual top latch.

8. The cowling latch assembly of claim 1 wherein the assembly further comprises a frame arm attached to a frame of the motor, the frame arm comprising a sensor, a lock pin configured to interface with a latch cam of the manual top latch, and the actuator.

9. The cowling latch assembly of claim 6 further comprising locking assembly on an interior of the cowling, the locking assembly defining a plate with an aperture engageable with the actuator in the actuator locked position.

10. A cowling latch assembly comprising:
an upper portion configured to attach to a cowling, wherein the upper portion includes a top latch, wherein the top latch is configured to rotate a latch cam;
a lower portion including a locking plate having a receiving aperture;
a frame arm including a sensor, a lock pin configured to interface with the latch cam, and a retractable locking actuator; and
a safety circuit controller configured to control the retractable locking actuator from a locked position to an unlocked position.

11. The cowling latch assembly of claim 10 wherein the sensor is in electronic communication with the safety circuit controller, and wherein the retractable locking actuator is in electronic communication with the safety circuit controller.

12. The cowling latch assembly of claim 10 wherein the retractable locking actuator comprises a solenoid.

13. The cowling latch assembly of claim 10 wherein the frame arm connects to an outboard motor.

14. The cowling latch assembly of claim 10 wherein the lower portion is integrated with the upper portion.

15. The cowling latch assembly of claim 10 wherein the upper portion is connected to a top of a cowling, and wherein the lower portion is connected to an inner surface of the cowling.

16. The cowling latch assembly of claim 10 wherein the upper portion further comprises a gripping protrusion.

17. The cowling latch assembly of claim 10 wherein the safety circuit controller is operable to move the locking actuator to the unlocked position if the manual top latch is in the unlocked position.

18. The cowling latch assembly of claim 10 wherein the safety circuit controller is operable to move the locking actuator to the unlocked position if a motor to which the cowling is attached is off.

19. The cowling latch assembly of claim 10 wherein the frame arm connects to an outboard motor, wherein the upper portion is connected to a top of a cowling, and wherein the lower portion is connected to an inner surface of the cowling, and wherein the cowling is removably attachable to the outboard motor.

20. A boat comprising the outboard motor of claim 19, and wherein the cowling is removably attached to the outboard motor.
